(19) United States
(12) Patent Application Publication
(10) Pub. No.: US 2006/0190861 A1
(43) Pub. Date: Aug. 24, 2006

(54) Method and apparatus for evaluating coverage of circuit, and computer product

(75) Inventor: Takashi Matsuura, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/214,843

(22) Filed: Aug. 31, 2005

(30) Foreign Application Priority Data
Jan. 19, 2005 (JP) 2005-012086

(51) Int. Cl. G06F 17/50

(52) U.S. Cl. 716/4

(57) ABSTRACT

An apparatus for evaluating coverage includes a determining unit that checks description rules when a receiving unit receives hardware description data. If the hardware description data matches a first or a second description rule, an optimizing unit performs a logic optimization by rewriting of the hardware description data according to the description rule matching. A computing unit computes total number of paths in the hardware description data for which the logic optimization is performed. An executing unit executes a logic simulation using the hardware description data for which the logic optimization is performed. A measuring unit measures path coverage.

### CROSS-REFERENCE TO RELATED APPLICATIONS

This application is based upon and claims the benefit of priority from the prior Japanese Patent Application No. 2005-012086, filed on Jan. 19, 2005, the entire contents of which are incorporated herein by reference.

### BACKGROUND OF THE INVENTION

1. Field of the Invention

The present invention relates to a method and apparatus for evaluating coverage of a circuit, and a computer product.

2. Description of the Related Art

Conventionally, in a large-scale integration (LSI) design, improvement of work efficiency by shortening a design period has been demanded. However, in the LSI design, a verification process, which is rather time consuming, to verify whether an LSI properly operates is essential. Especially for an LSI that is required to be large-scale, to have high performance, to be high-speed, and to be low-power consuming, the verification process is important for a purpose of maintaining high quality.

To improve efficiency in verification, an effective simulation pattern or test bench should be applied to simulation. A code coverage is one of verification work used to complement the simulation. The code coverage is a method that involves a quantitative measurement to determine whether a hardware description in a hardware description language (HDL) at a register transfer level (RTL) is actually executed by the simulation pattern or the test bench.

The code coverage includes a path coverage that focuses on a flow of a process. The path coverage analyzes whether each of routes, in other words, each of paths has been followed in such a case that multiple conditions, which produce various paths depending on combination, are present in conditional branch statements, such as an if statement and a case statement.

According to a conventional technology used in a coverage evaluation system disclosed in Japanese Patent Laid-Open Publication No. 2001-14365, when evaluating coverage of test data used for testing functions of a logical circuit, description not covered by a verification test is accurately measured and creation of unnecessary tests is prevented, thereby omitting unnecessary work such as unnecessary simulation.

A method disclosed in Japanese Patent Laid-Open Publication No. 2004-192062 includes an operation of recording an execution history for each description block in the hardware description, and if the same description blocks are executed at the same time, an execution history corresponding to previous execution is deleted, thereby preventing counting errors during measurement of the coverage.

However, in the path coverage method described above, the total number of paths is calculated by multiplying the number of paths in each exclusive branch regardless of an output. Thus, descriptions including paths that are never generated, or descriptions including different branches for each output are included in the hardware description. As a result, the total number of paths becomes massive.

If simulation is executed when the total number of paths is massive, time required for the simulation proportionately increases, resulting in an increased verification period. Furthermore, in some cases, it becomes impossible to carry out the measurement of the path coverage itself.

Especially in the conventional technologies described above, it cannot be determined whether the hardware description includes such descriptions that generate a massive number of paths before executing the simulation. Therefore, a verifier cannot recognize that the total number of paths is massive in advance. Consequently, it is impossible to prevent such problems that the verification period becomes long or that the measurement of the path coverage cannot properly be performed.

### SUMMARY OF THE INVENTION

It is an object of the present invention to solve at least the above problems in the conventional technology.

An apparatus for evaluating coverage according to one aspect of the present invention includes a receiving unit that receives hardware description data of a circuit; a determining unit that determines whether it is possible to compress number of paths in the hardware description data; and an optimizing unit that optimizes the hardware description data based on determination by the determining unit.

An apparatus for evaluating coverage according to another aspect of the present invention includes a receiving unit that receives hardware description data of a circuit; a determining unit that determines whether it is possible to compress number of paths in the hardware description data; and a computing unit that computes total number of paths in the hardware description data based on determination by the determining unit.

A method of evaluating coverage according to still another aspect of the present invention includes receiving hardware description data of a circuit; determining whether it is possible to compress number of paths in the hardware description data; and optimizing the hardware description data based on determination at the determining.

A method of evaluating coverage according to still another aspect of the present invention includes receiving hardware description data of a circuit; determining whether it is possible to compress number of paths in the hardware description data; and computing total number of paths in the hardware description data based on determination at the determining.

A computer-readable recording medium according to still another aspect of the present invention stores a computer program for realizing a method for evaluating coverage according to the above aspects.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic of a hardware configuration of an apparatus for evaluating coverage according to embodiments of the present invention;

FIG. 2 is a block diagram of a functional configuration of the apparatus shown in FIG. 1;

FIG. 3 is a flowchart of a coverage evaluation process according to the embodiments;

FIG. 4 is a schematic for illustrating hardware description data used in the apparatus shown in FIG. 1;

FIGS. 5A to 5C are schematics for illustrating the hardware description data shown in FIG. 4 in a form of a flowchart;

FIG. 6 is a schematic for illustrating hardware description data newly obtained by rewriting the hardware description data shown in FIG. 4 to equivalent “case” statements;

FIG. 7 is a schematic for illustrating the hardware description data shown in FIG. 6 in a form of a flowchart;

FIG. 8 is a schematic for illustrating a case statement 611 shown in FIG. 6 in a form of a flowchart;

FIG. 9 is a schematic for illustrating a case statement 612 shown in FIG. 6 in a form of a flowchart;

FIG. 10 is a schematic for illustrating a case statement 613 shown in FIG. 6 in a form of a flowchart;

FIG. 11 is a schematic for illustrating hardware description data according to a second embodiment of the present invention;

FIG. 12 is a schematic for illustrating the hardware description data shown in FIG. 11 in a form of a flowchart;

FIG. 13 is a schematic for illustrating hardware description data newly obtained by rewriting the hardware description data shown in FIG. 11 to avoid duplication in an input condition;

FIG. 14 is a schematic for illustrating the hardware description data shown in FIG. 13 in a form of a flowchart; and

FIG. 15 is a schematic for illustrating hardware description data according to a third embodiment of the present invention.

### DETAILED DESCRIPTION OF THE PREFERRED EMBODIMENTS

Exemplary embodiments according to the present invention will be explained in detail below with reference to the accompanying drawings.

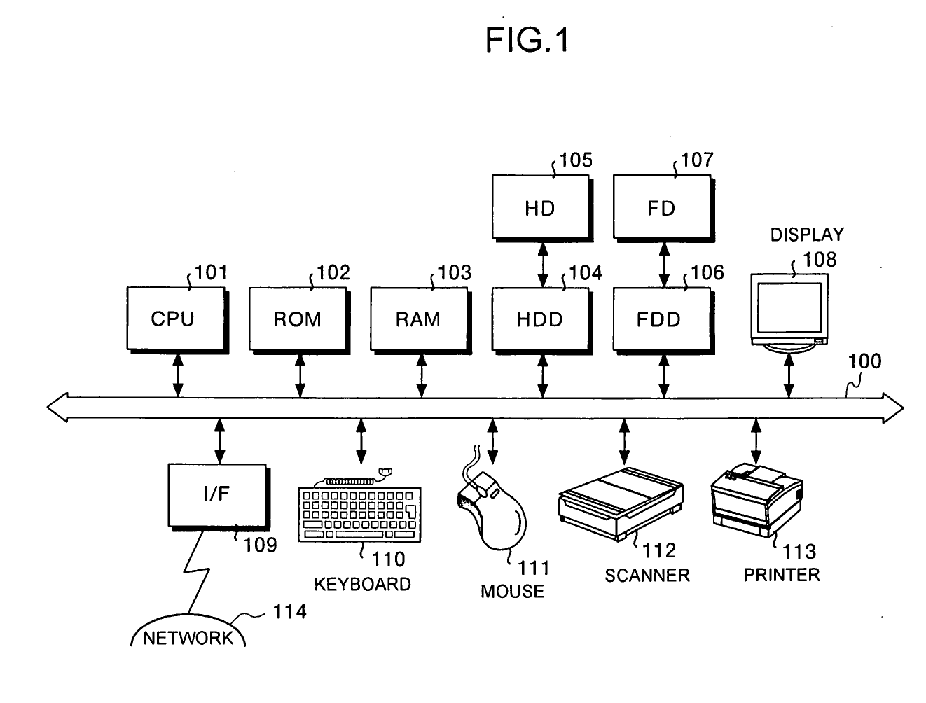

FIG. 1 is a schematic of a hardware configuration of an apparatus for evaluating coverage according to embodiments of the present invention. As shown in FIG. 1, the apparatus includes a central processing unit (CPU) 101, a read only memory (ROM) 102, a random access memory (RAM) 103, a hard disk drive (HDD) 104, a hard disk (HD) 105, a flexible disk drive (FDD) 106, a flexible disk (FD) 107 as an example of a removable recording medium, a display 108, an interface (I/F) 109, a keyboard 110, a mouse 111, a scanner 112, and a printer 113. Each of components is connected through a bus 100.

The CPU 101 controls a whole of the apparatus. The ROM 102 stores programs such as a boot program. The RAM 103 is used as a work area of the CPU 101. The HDD 104 controls reading/writing of data from/to the HD 105 in accordance with a control by the CPU 101. The HD 105 stores data written in accordance with the control by the HDD 104

The FDD 106 controls reading/writing of data from/to the FD 107 in accordance with the control by the CPU 101. The FD 107 stores data written in accordance with the control by the FDD 106 and causes the apparatus to read data stored in the FD 107.

Apart from the FD 107, a compact disk-read only memory (CD-ROM), a magneto optic (MO) disk, a digital versatile disk (DVD) or a memory card can also be used as a removable recording medium. The display 108 displays data pertaining to cursor, icons, toolbox as well as text, image, functions etc. A cathode ray tube (CRT), a thin film transistor (TFT) crystal display, and a plasma display may be used as the display 108.

The I/F 109 is connected to a network 114 such as the Internet through a communication line and is connected to other devices through the network 114. The I/F 109 controls the network 114 and an internal interface to control input/output of data to/from external devices. A modem or a local area network (LAN) adapter can be used as the I/F 109.

The keyboard 110 includes keys for inputting characters, numbers, and various instructions, and is used to input data. A touch panel input pad or a numerical key pad may also be used as the keyboard 110. The mouse 111 is used to shift the curser, select a range, shift windows, and change sizes of the windows on a display. A track ball or a joy stick may be used as a pointing device if functions similar to those of the mouse 111 are provided.

The scanner 112 optically captures an image and inputs image data to the apparatus. The scanner 112 may be provided with an optical character read (OCR) function. The printer 113 prints the image data and document data. For example, a laser printer or an inkjet printer may be used as the printer 113.

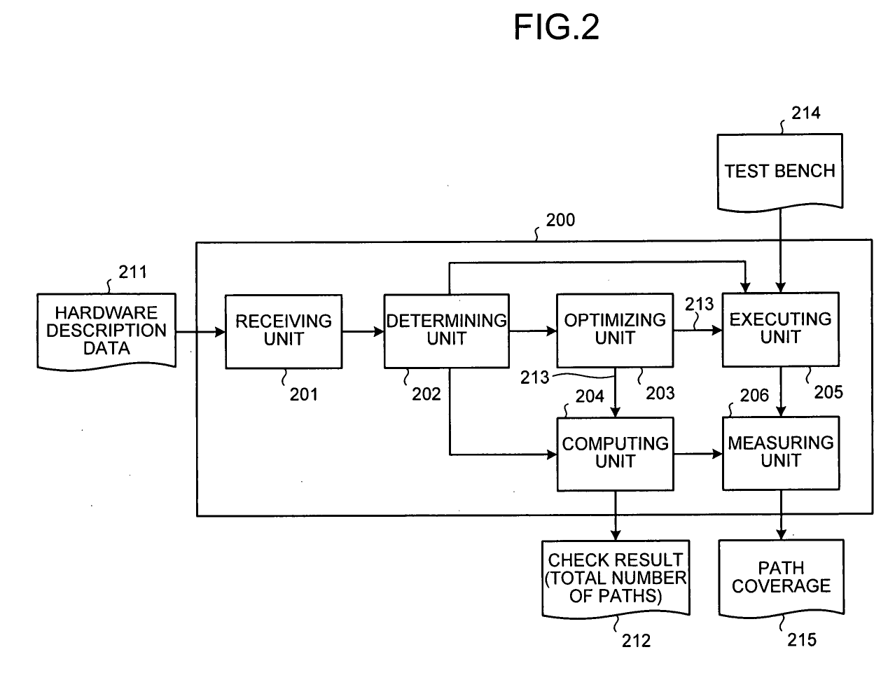

FIG. 2 is a block diagram of a functional configuration of the apparatus. As shown in FIG. 2, an apparatus for evaluating coverage 200 includes a receiving unit 201, a determining unit 202, an optimizing unit 203, a computing unit 204, an executing unit 205, and a measuring unit 206.

The receiving unit 201 receives hardware description data 211 of a circuit. The circuit is, for example, a logic circuit to be evaluated by the path coverage. The hardware description data 211 is description data written in the HDL at the RTL of the circuit. For example, the description data can be written in a verilog HDL or a VHSIC HDL (VHDL).

The determining unit 202 determines whether the total number of paths in the hardware description data 211 can be compressed. To be specific, the determining unit 202 determines whether conditional branch statements included in the hardware description data 211 are if-if statements equivalent to case statements. The determining unit 202 also determines whether there is duplication in input conditions of the conditional branch statements. Furthermore, the determining unit 202 determines whether an output variable from one of the conditional branch statements is independent from output variables from others of the conditional branch statements.

To be more specific, the determining unit 202 determines whether the hardware description data 211 matches description rules (1) to (3).

(1) “there are if-if statements equivalent to case statements”

(2) “there is a duplication in input conditions between if statements, between case statements, or between an if statement and a case statement”

(3) “there are outputs from an unrelated if statements or case statements in a single measuring unit”

Such determination based on the description rules is performed in a predetermined measuring unit. The measuring unit is, for example, a range of an always statement in a case of the Verilog HDL, and of a process statement in a case of the VHDL.

The optimizing unit 203 optimizes description contents of the hardware description data 211 based on a result of determination by the determining unit 202. To be specific, when the description contents match the description rules (1) and (2), the optimizing unit 203 rewrites the hardware description data 211 according to the description rules.

The computing unit 204 computes the total number of paths (a check result 212). To be specific, the computing unit 204 computes the total number of paths (the check result 212) of hardware description data 213 newly obtained by optimizing the description contents. Furthermore, when the description contents match the description rule (3), the computing unit 204 computes the total number of paths in the hardware description data 211 based on the number of paths for each output variable.

The executing unit 205 is a logic simulator that performs a logic simulation using the hardware description data 213 newly obtained. When the description contents match the description rule (3), the executing unit 205 executes logic simulation the hardware description data 211 input. The logic simulation is executed with the aid of a test bench 214.

The measuring unit 206 measures path coverage 215 of the object circuit based on the total number of paths computed by the computing unit 204 and the result of execution by the executing unit 205. In other words, the total number of paths computed by the computing unit 204 becomes a denominator of the path coverage 215, and a result obtained from the logic simulation becomes a numerator of the path coverage 215.

To be specific, functions of the receiving unit 201, the determining unit 202, the optimizing unit 203, the computing unit 204, the executing unit 205, and the measuring unit 206 are realized, for example, by the CPU 101 executing programs recorded on the ROM 102, the RAM 103, the HD 105, and the FD 107, or by the I/F 109 shown in FIG. 1.

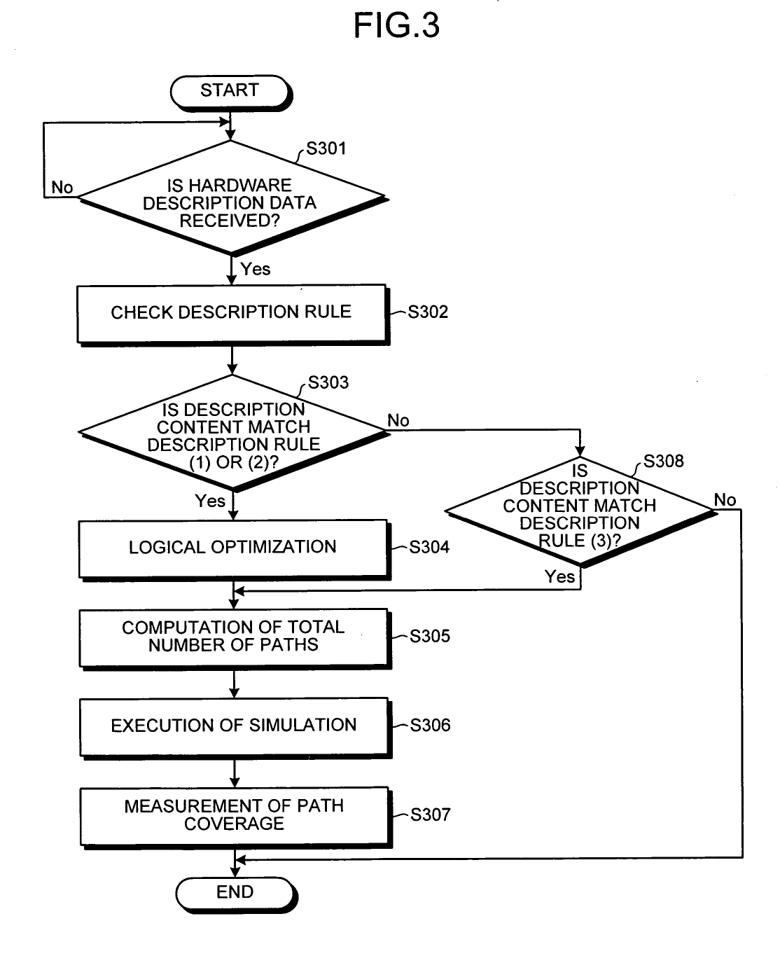

FIG. 3 is a flowchart of a coverage evaluation process according to the embodiments. As shown in FIG. 3, when the hardware description data 211 is received by the receiving unit 201 (“YES” at step S301), the determining unit 202 performs a check based on the description rules (step S302).

If the description contents match the description rules (1) and (2) (“YES” at step S303), the optimizing unit 203 logically optimizes or rewrites the hardware description data 211 according to the description rules matching (step S304). The computing unit 204 computes the total number of paths in the hardware description data 213 logically optimized (step S305). The total number of paths computed is far smaller than the total number of paths in the hardware description data 211 input. Thus, compression of the number of paths is achieved.

The executing unit 205 executes a logic simulation using the hardware description data 213 and the test bench 214 (step S306). Finally, the measuring unit 206 measures the path coverage 215 (step S307).

If the description contents of the hardware description data 211 do not match the description rules (1) or (2) (“NO” at step S303), the determining unit 202 determines whether the description contents match the description rule (3) (step S308). If the description contents match the description rule (3) (“YES” at step S308), the process proceeds to step S305, and the computing unit 204 computes the total number of paths. The total number of paths of the hardware description data 211 input is computed without performing the logic optimization (step S304).

If the determining unit 202 determines that the description contents do not match the description rule (3) at step S308 (“NO” at step S308), the coverage evaluation process ends, and a normal coverage evaluation process is performed. In other words, the executing unit 205 executes a logic simulation using the hardware description data 211 and the test bench 214, and the measuring unit 206 measures the path coverage 215.

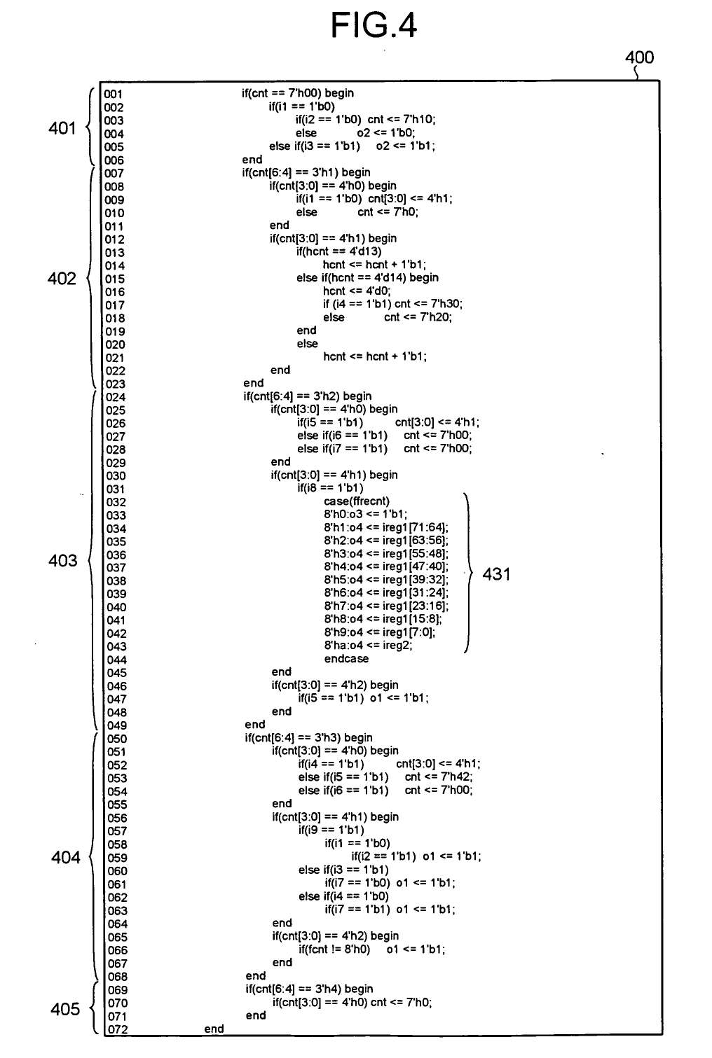

The coverage evaluation when the description contents match the description rule (1) is explained in a first embodiment. If an exclusive logic does not include a case statement or an if-else statement, a non-occurring path never to be taken is generated during simulation. Similarly, a case in which the exclusive logic includes if-if statements also causes generation of the non-occurring path during the simulation. Hardware description data that includes an if-if statement is shown in FIG. 4. FIG. 4 is a schematic for illustrating hardware description data 400 used in the apparatus 200 according to the first embodiment. A line number is provided on a left end of the hardware description data 400.

The hardware description data 400 includes five of if statements 401 to 405 branched by cnt. Each of the if statements 401 to 405 further includes an if statement, and thus forming an if-if statement. A case statement 431 is included in the if statement 403. In the hardware description data 400, because all the cnt values are exclusive, then clause of each of the if statements 401 to 405 cannot be executed simultaneously.

However, in the hardware description data 400, except the first if statement 401, first line of each of the if statements 402 to 405 contains different constants, 3′h1, 3′h2, 3′h3, and 3′h4 respectively, assigned for variable cnt[6:4]. Accordingly, the determining unit 202 determines that the if statements 402 to 405 are the if-if statements logically equivalent to the case statements. Thus, the optimizing unit 203 can rewrite the if statements 402 too 405 to the case statements, thereby enabling the optimizing unit 203 to optimize the hardware description data 400.

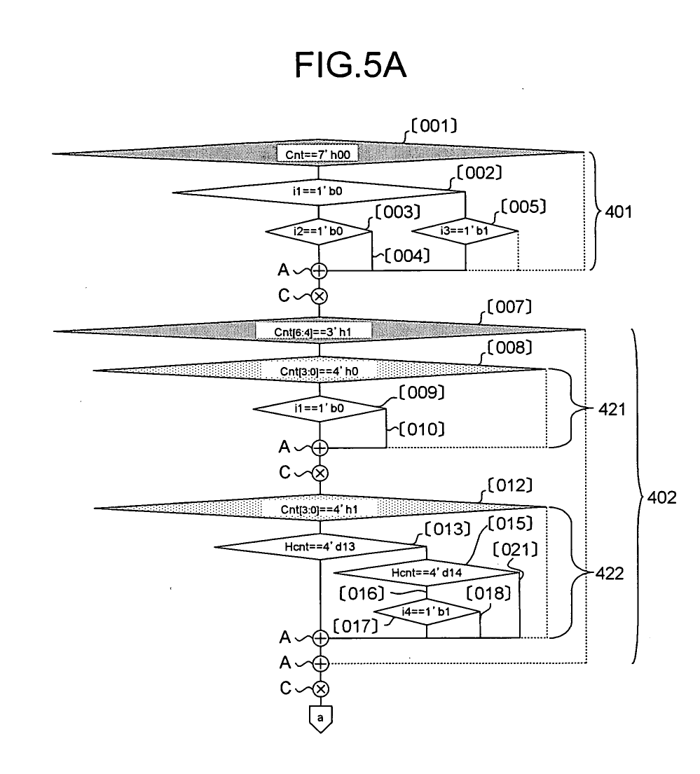

FIGS. 5A to 5C are schematics for illustrating the hardware description data 400 shown in FIG. 4 in a form of a flowchart. In FIG. 5A to FIG. 5C, line numbers ([xxx]) corresponding to that shown in FIG. 4 are provided.

The if statement is indicated by a rhomboid figure. Execution of the then clause of the if statement is indicated by a line drawn downwards from a bottom crest at the center of the rhomboid figure. Execution of an else clause of the if statement is indicated by a line drawn downwards from a left or a right crest of the rhomboid figure. Solid lines indicate statements described in the hardware description data 400. Broken lines indicate implicit statements not described in the hardware description data 400.

A circle indicates an operator for calculating the number of paths. An operator A having an operation symbol “+” adds the number of connections of the lines from the rhomboid figures. The operator A of the if statement 401 shown in FIG. 5A is taken as an example. The operator A of the if statement 401 is connected to five lines from the rhomboid figures. Specifically, the operator A of the if statement 401 is connected to two lines from [003], two lines from [005] and one line from (broken line) [001]. Thus, the total number of paths of the if statement 401 is 5.

An operator C having operation symbol “×” multiplies the total numbers of paths obtained based on the operators A having operation symbol “+” of the if statements placed above and below the operator C. For example, as shown in FIG. 5A, the operator C placed between the total number of paths of the if statement 401 and if statement 402 multiplies the total number of paths of the if statement 401 and the total number of paths of the if statement 402.

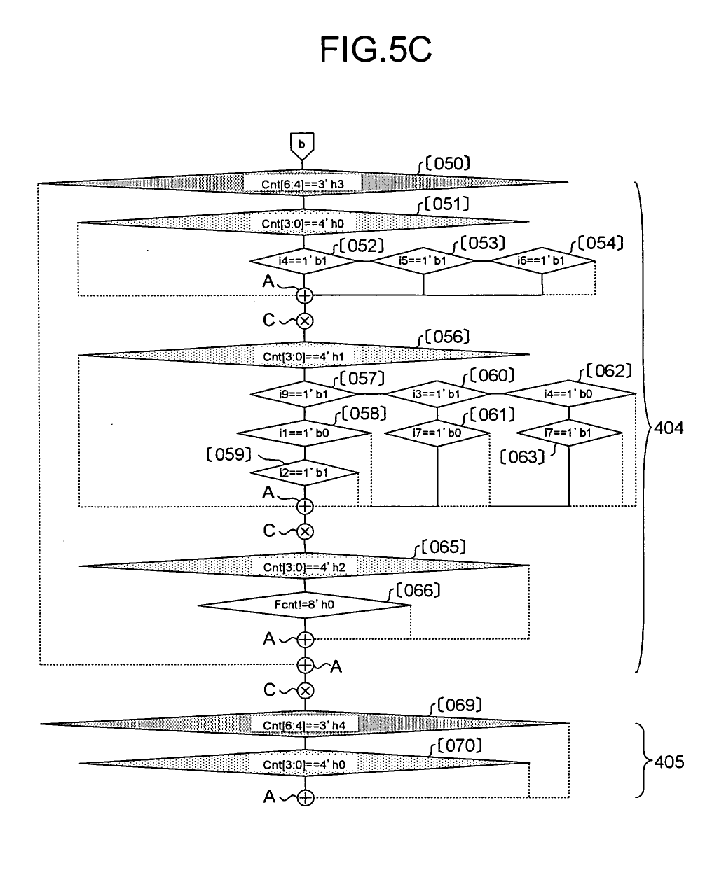

The case statement is indicated by figures that vertically divide the rhomboid figures and include vertical lines between the divided parts. For example, as shown in FIG. 5B, the case statement 431 includes 11 of then clauses and 1 of implicit default clause, which is not included in the case statement 431. Thus, the total number of paths of the case statement 431 is 12. The patters and the symbols shown in FIGS. 5A to 5C have the similar meanings in FIGS. 7 to 10, FIG. 12, and FIG. 14.

As shown in FIGS. 5A to 5C, number of paths P1 of the if statement 401 is 5. Similarly, number of paths P2 of the if statement 402 is 16 (3 (number of paths of the if statement 421)×5 (number of paths of the if statement 422)+1 (implicit else clause of [007])). Number of paths P3 of the if statement 403 is 211 (5×14×3+1).

Number of paths P4 of the if statement 404 is 136 (5×9×3+1). Number of paths P5 of the if statement 405 is 3. Thus, by also counting implicit else statements (else clauses not described) during measurement of the path coverage, total number of paths P of the hardware description data 400 is obtained by multiplying the numbers of paths P1 to P5 pertaining to each of the if statements 401 to 405.
P=P1×P2×P3×P4×P5=5×(3×5+1)×(5×14×3+1)×(5×9×3+1)×3=6887040

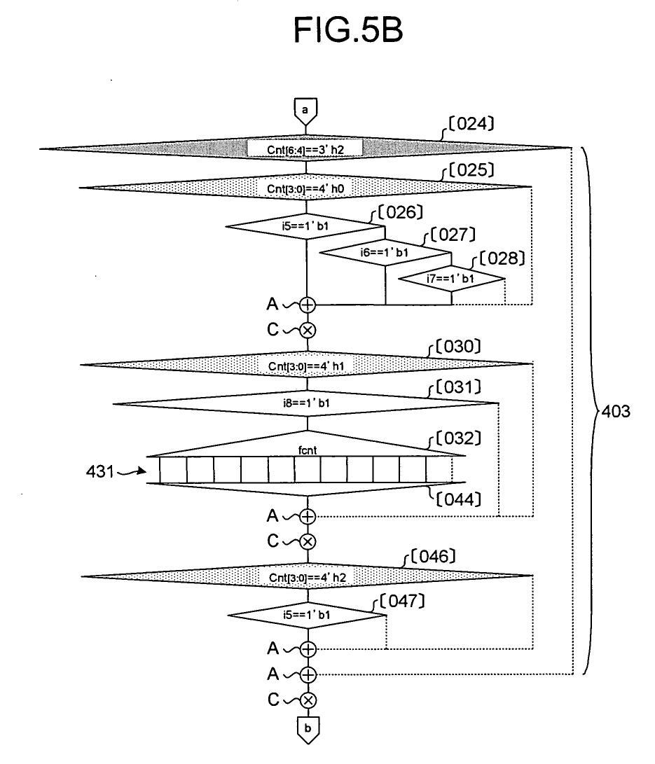

Because the hardware description data 400 matches the description rule (1), the hardware description data 400 can be rewritten in case statements. FIG. 6 is a schematic for illustrating hardware description data newly obtained by rewriting the hardware description data 400 to equivalent case statements. The components having the same configuration as the constituents shown in FIG. 4 are indicated by the same reference characters, and the detailed explanation is omitted.

In hardware description data 600, the if statements 402 to 405 shown in FIG. 4 are rewritten in a case statement 602 (case statements 611 to 614). FIG. 7 is a schematic for illustrating the hardware description data 600 shown in FIG. 6 in a form of a flowchart. Line numbers shown in FIG. 6 (marked as [xxx]) are used in FIG. 7. As shown in FIG. 7, numerals inside the case statements 611 to 613 indicate the numbers of paths of each of the case statements 611 to 613. A numeral inside [078] indicates the number of paths of the case statement 602.

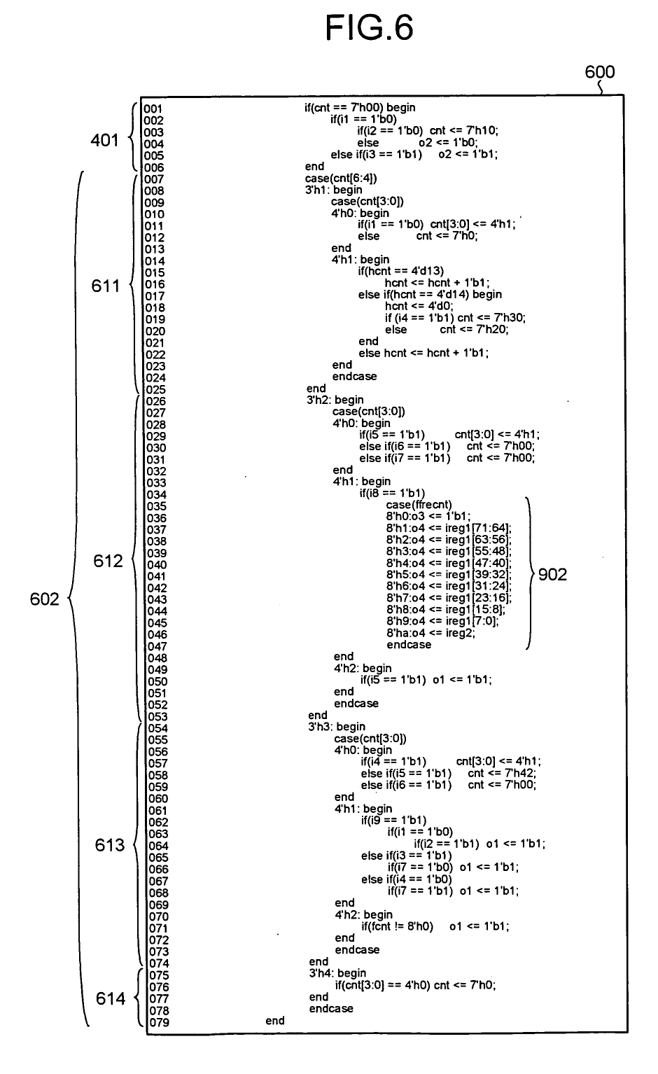

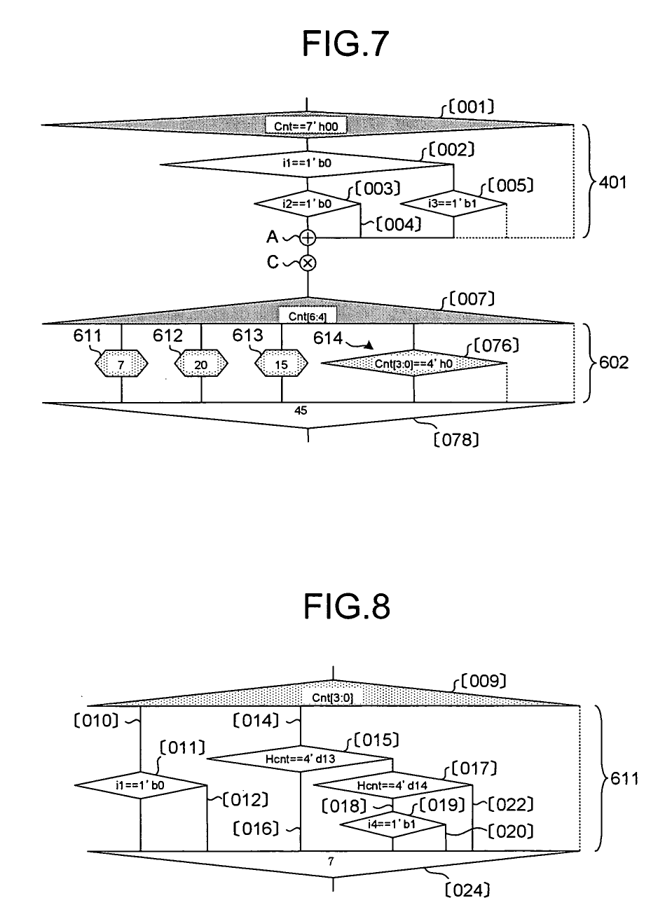

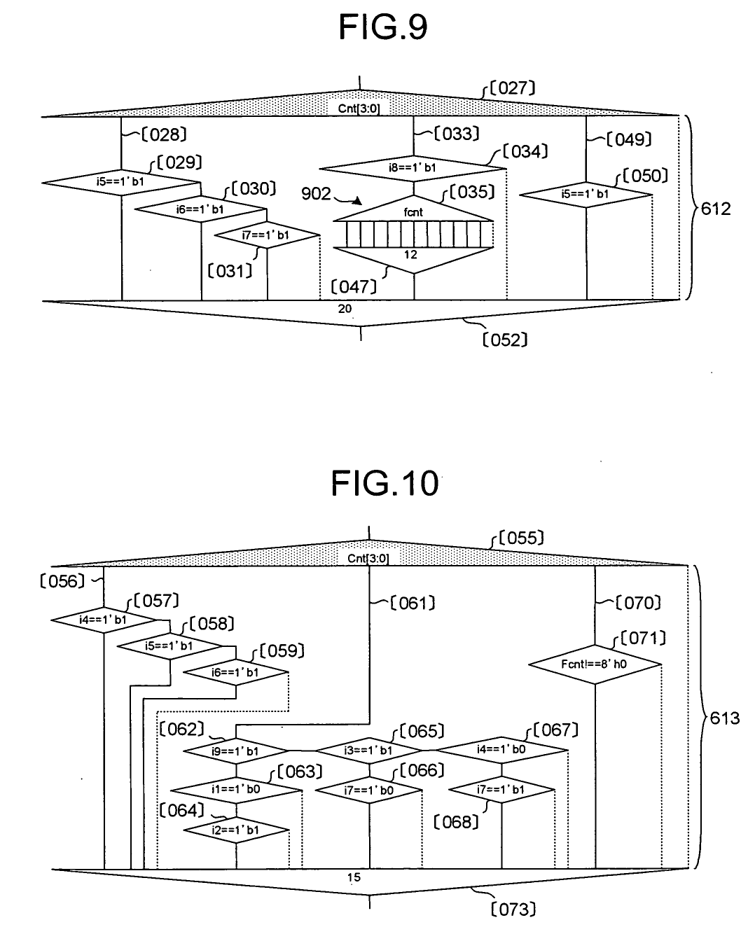

FIG. 8 is a schematic for illustrating the case statement 611 shown in FIG. 6 in a form of a flowchart. FIG. 9 is a schematic for illustrating the case statement 612 shown in FIG. 6 in a form of a flowchart. FIG. 10 is a schematic for illustrating the case statement 613 shown in FIG. 6 in a form of a flowchart.

As shown in FIGS. 6 to 10, by rewriting an if-if statements having different constants for the same variable to a case statement, the total number of paths p of the hardware description data 600 newly obtained by rewriting is acquired by multiplying the number of paths P1 of the if statement 401 and the number of paths p2 of the case statement 602. The number of paths p2 is a sum of number of paths p11 (p11=7) of the case statement 611, number of paths p12 (p12=20) of the case statement 612, number of paths p13 (p13=15) of the case statement 613, number of paths p14 (p14=2) of the if statement 614, and number of paths (1) of the case statement 602 due to an implicit default clause. Thus, the total number of paths p of the hardware description data 600 is computed as follows.

$$\begin{matrix}p = P 1 \times ( p 11 + p 12 + p 13 + p 14 + 1 ) \\ = 5 \times ( 7 + 20 + 15 + 2 + 1 ) \\ = 225\end{matrix}$$

The total number of paths P of the hardware description data 400 before rewriting is 6887040. Thus, by rewriting the hardware description data 400, the total number of paths is compressed by about 1/30000, thereby enabling optimization of the hardware description data 400.

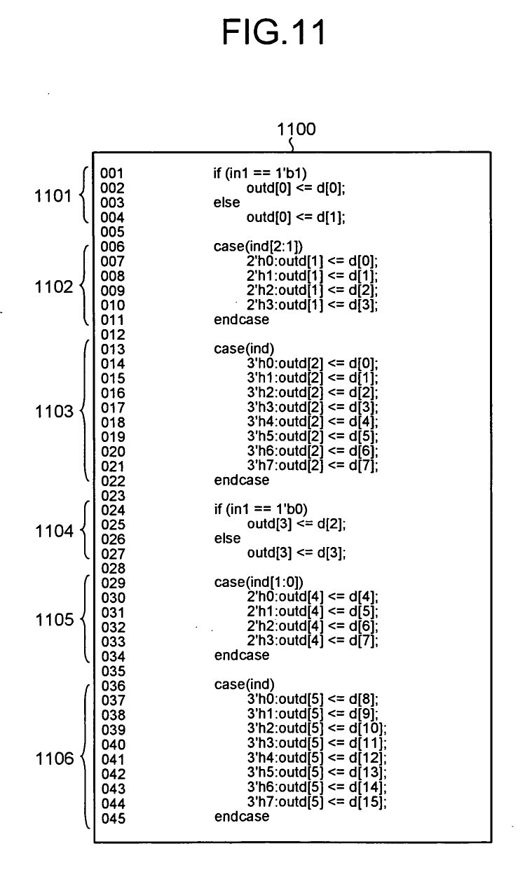

The coverage evaluation when the description contents match the description rule (2) is explained in a second embodiment. A non-occurring path is also generated during simulation when input conditions of case statements or if statements in a measuring unit of the path coverage include duplication. FIG. 11 is a schematic for illustrating hardware description data according to the second embodiment. Line numbers of hardware description data 1100 are indicated at a left end. As shown in FIG. 11, the hardware description data 1100 includes two of if statements 1101 and 1104 having the same variable as input condition, case statements 1102 and 1103 that follow the if statement 1101, and case statements 1105 and 1106 that follow the if statement 1104.

In the hardware description data 1100, inl is the input condition for the if statements 1101 and 1104. A then clause ([002]) of the if statement 1101 is included in an else clause ([026]) of the if statement 1104, thereby making the input condition duplicate. Similarly, a then clause ([024]) of the if statement 1104 is also included in an else clause ([004]) of the if statement 1001, thereby making the input condition duplicate. Accordingly, the description contents of the hardware description data 1100 match the description rule (2). Also in four of the case statements 1102, 1103, 1105, and 1106 having ind as the input condition, branches other than heads of each of the case statements 1102, 1103, 1105, and 1106 cannot be executed simultaneously when ind=3′h0.

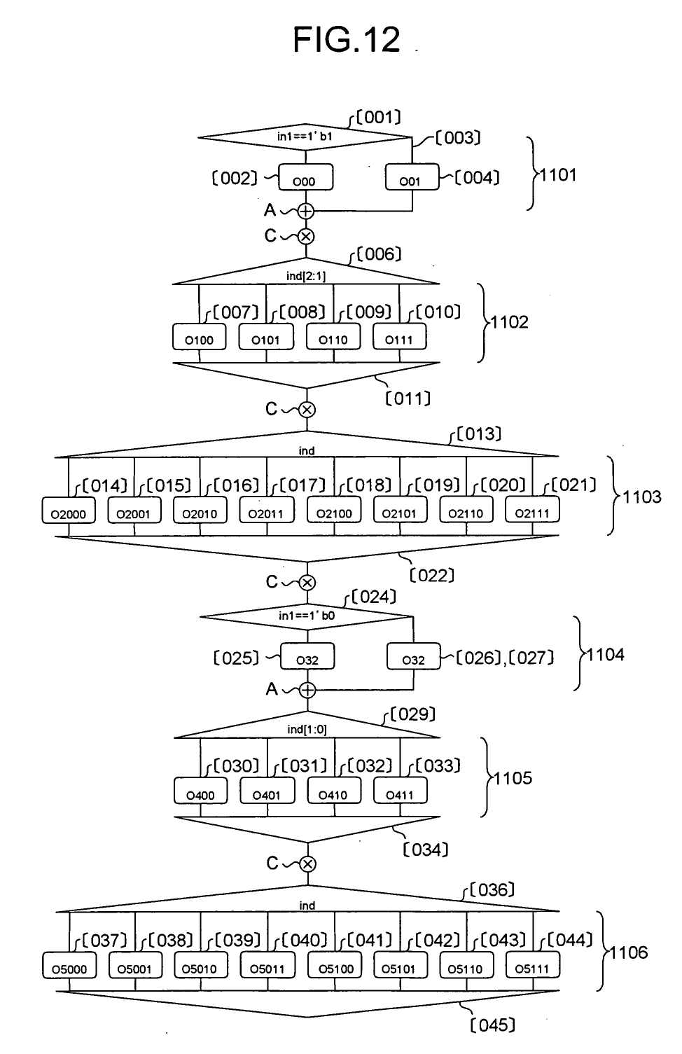

FIG. 12 is a schematic for illustrating the hardware description data 1100 shown in FIG. 11 in a form of a flowchart. Line numbers ([xxx]) corresponding to that shown in FIG. 11 are provided in FIG. 12. Because number of paths is counted exclusively in measurement of the path coverage, total number of paths Q of the hardware description data 1100 is computed by multiplying number of paths Q1 of the if statement 1101, number of paths Q2 of the case statement 1102, number of paths Q3 of the case statement 1103, number of paths Q4 of the if statement 1104, number of paths Q5 of the case statement 1105, and number of paths Q6 of the case statement 1106. In other words, the total number of paths Q of the hardware description data 1100 is computed as follows.

$$\begin{matrix}Q = Q 1 \times Q 2 \times Q 3 \times Q 4 \times Q 5 \times Q 6 \\ = 2 \times 4 \times 8 \times 2 \times 4 \times 8 \\ = 4096\end{matrix}$$

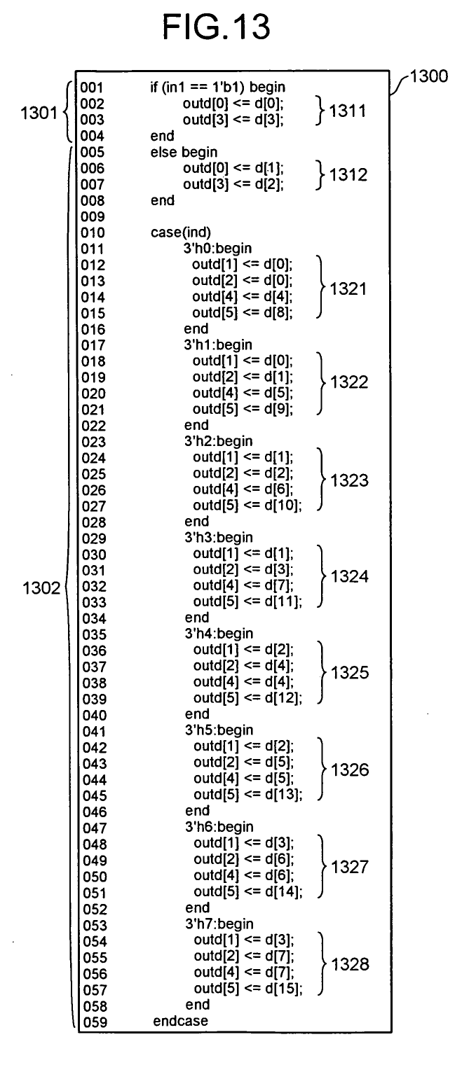

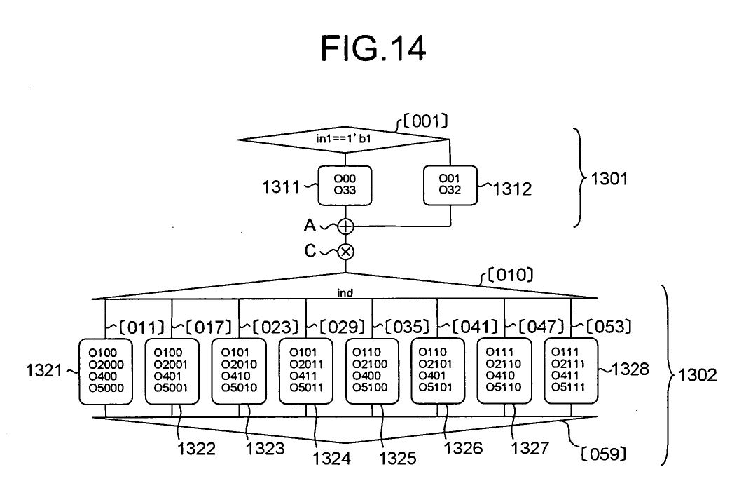

Because the description contents of the hardware description data 1100 match the description rule (2), the hardware description data 1100 needs to be rewritten to avoid duplication in the input condition. FIG. 13 is a schematic for illustrating hardware description data newly obtained by rewriting the hardware description data 1100 shown in FIG. 11 to avoid duplication in the input condition. FIG. 14 is a schematic for illustrating the hardware description data shown in FIG. 13 in a form of a flowchart. As shown in FIG. 14, line numbers ([xxx]) corresponding to that in FIG. 13 are provided.

Comparing FIG. 11 and FIG. 13 (or FIG. 12 and FIG. 14), a then clause 1311 of the if statement 1301 shown in FIG. 13 is a description summarizing the then clause [002] and an else clause [027] shown in FIG. 11. Similarly, a then clause 1312 of the case statement 1302 shown in FIG. 13 is a description summarizing the else clause [004] and a then clause [025] shown in FIG. 11.

A case statement 1321 shown in FIG. 13 is a description summarizing the case statements [007], [014], [030], and [037] shown in FIG. 11. A case statement 1322 shown in FIG. 13 is a description summarizing the case statements [007], [015], [031], and [038] shown in FIG. 11. A case statement 1323 shown in FIG. 13 is a description summarizing the case statements [008], [0016], [0032], and [0039] shown in FIG. 11. A case statement 1324 shown in FIG. 13 is a description summarizing the case statements [008], [017], [033], and [040] shown in FIG. 11.

A case statement 1325 shown in FIG. 13 is a description summarizing the case statements [009], [018], [030], and [041] shown in FIG. 11. A case statement 1326 shown in FIG. 13 is a description summarizing the case statements [009], [019], [032], and [042] shown in FIG. 11. A case statement 1327 shown in FIG. 13 is a description summarizing the case statements [010], [020], [032], and [043] shown in FIG. 11. A case statement 1328 shown in FIG. 13 is a description summarizing the case statements [010], [021], [033], and [044] shown in FIG. 11.

Total number of paths q of hardware description data 1300 newly obtained by rewriting is computed by multiplying number of paths q1 of the if statement 1301 (2 as shown in FIG. 14) and number of paths q2 of the case statement 1302 (8 as shown in FIG. 14).

$$\begin{matrix}q = q 1 \times q 2 \\ = 2 \times 8 \\ = 16\end{matrix}$$

The total number of paths Q of the hardware description data 1100 before rewriting is 4096. Thus, the total number of paths q of the hardware description data 1300 can be reduced (compressed) by 1/256 by the logical optimization.

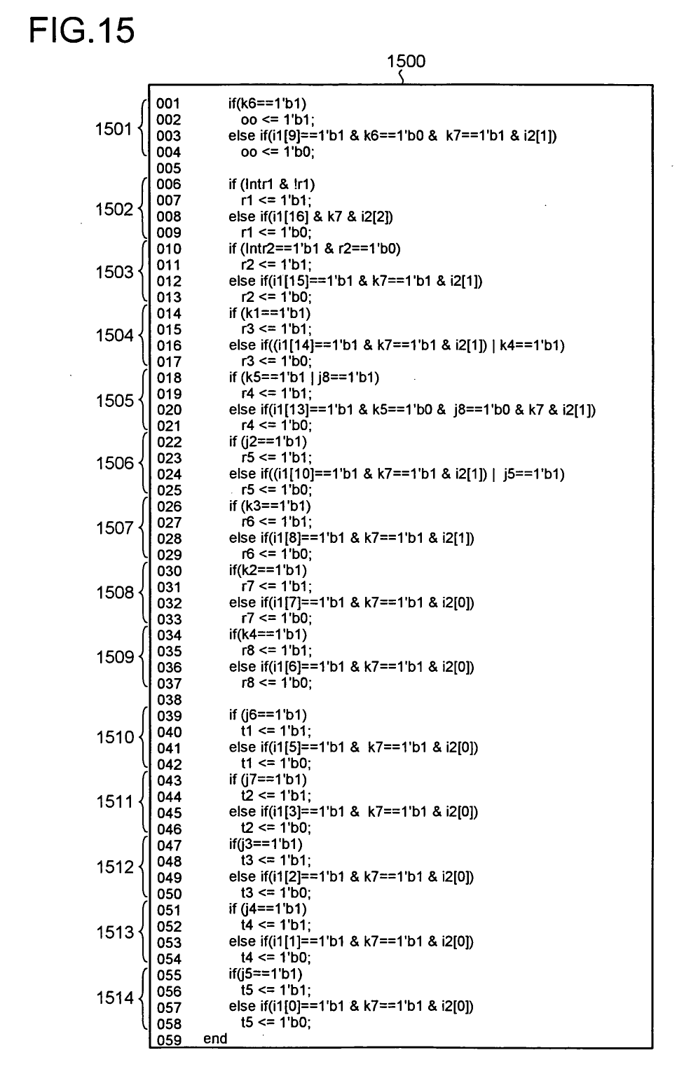

The coverage evaluation when the description contents match the description rule (3) is explained in a third embodiment. FIG. 15 is a schematic for illustrating hardware description data according to the third embodiment. In hardware description data 1500, each variable output from a case statement or an if statement in a measuring unit is independent and unrelated to other outputs. In other words, variables oo, rc (rc=r1 to r8), tx (tx=t1 to t5) in if statements 1501 to 1514 shown in FIG. 15 are not mixed with output from other if statements. Thus, the hardware description data 1500 matches the description rule (3). Because each of the if statements is independent, the hardware description data 1500 does not need to be optimized.

Numbers of paths are counted exclusively in the path coverage measurement of the hardware description data 1500. Number of paths r of each of 14 of the if statements 1501 to 1514 computed from the then clause, the else if clause, and the implicit else clause, is 3. Thus, total number of paths R of the hardware description data 1500 is computed as follows.

$$\begin{matrix}R = {r}^{14} \\ = {3}^{14} \\ = 4782969\end{matrix}$$

When summing up number of paths for each output variable (oo, rc, tx), if number of paths for output variable oo is taken as Roo, number of paths for output variable rc is taken as Rrc, and number of paths for output variable tx is taken as Rtx, total number of paths R1 is computed as follows (because Roo=1, Rrc=8, and Rtx=5).
R1=3¹+3⁸+3⁵=6809

Thus, the total number of paths R1 of the hardware description data 1500 is reduced by 1/700. When summing up number of paths for every single bit of output, total number of paths R2 is computed as follows.
R2=3×14=42

Thus, the total number of paths R2 of the hardware description data 1500 can be reduced (compressed) by 1/100000. Moreover, in the third embodiment, because description contents of the hardware description data 1500 do not need to be optimized unlike the first and the second embodiments, the verification period can be minimized even more effectively than in the first and the second embodiments.

According to the method and apparatus for evaluating coverage, and the computer product, number of paths of hardware description data can be reduced before executing logic simulation. Thus, simulation using the hardware description including massive paths in path coverage measurement of a logical circuit can be prevented beforehand, and verification period can be reduced.

The method for evaluating coverage explained in the embodiments can be realized by executing a program prepared in advance by a computer such as a personal computer and a workstation. The program can be recorded on a computer readable recording medium such as the HD, the FD, the CD-ROM, the MO, and the DVD, and is executed by the computer reading out from the recording medium. The computer program may be a transmission medium that is distributed through a network such as the Internet.

According to the present invention, it is possible to prevent simulation using a hardware description including massive paths, and to reduce a verification period.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An apparatus for evaluating coverage, comprising:
a receiving unit that receives hardware description data of a circuit;
a determining unit that determines whether it is possible to compress number of paths in the hardware description data; and
an optimizing unit that optimizes the hardware description data based on determination by the determining unit.

2. The apparatus according to claim 1, wherein
the determining unit determines whether a conditional branch statement included in the hardware description data is an if-if statement that is equivalent to a case statement; and
the optimizing unit optimizes the hardware description data by rewriting, when the determining unit determines that the conditional branch statement is the if-if statement equivalent to the case statement, the hardware description data from the if-if statements to the case statement.

3. The apparatus according to claim 1, wherein
the determining unit determines whether there is a duplication in input conditions of a plurality of conditional branch statements included in the hardware description data; and
the optimizing unit optimizes the hardware description data by rewriting the hardware description data to avoid the duplication.

4. The apparatus according to claim 1, further comprising a computing unit that computes total number of paths in the hardware description data optimized.

5. The apparatus according to claim 4, further comprising:
an executing unit that executes a logic simulation using the hardware description data optimized; and
a measuring unit that measures path coverage of the circuit based on the total number and a result of the logic simulation.

6. An apparatus for evaluating coverage, comprising:
a receiving unit that receives hardware description data of a circuit;
a determining unit that determines whether it is possible to compress number of paths in the hardware description data; and
a computing unit that computes total number of paths in the hardware description data based on determination by the determining unit.

7. The apparatus according to claim 6, wherein
the determining unit determines whether, among conditional branch statements included in the hardware description data, an output variable from one of the conditional branch statements is independent from output variables from others of the conditional branch statements; and
the computing unit computes total number of paths in the hardware description data based on number of paths for each output variable when it is determined that the output variable of the one is independent.

8. The apparatus according to claim 7, further comprising:
an executing unit that executes a logic simulation using the hardware description data based on determination by the determination unit; and
a measuring unit that measures path coverage of the circuit based on the total number and a result of the logic simulation.

9. A method of evaluating coverage, comprising:
receiving hardware description data of a circuit;
determining whether it is possible to compress number of paths in the hardware description data; and
optimizing the hardware description data based on determination at the determining.

10. The method according to claim 9, further comprising computing total number of paths in the hardware description data optimized.

11. A method of evaluating coverage, comprising:
receiving hardware description data of a circuit;
determining whether it is possible to compress number of paths in the hardware description data; and
computing total number of paths in the hardware description data based on determination at the determining.

12. A computer-readable recording medium that stores a computer program for evaluating coverage, the computer product making a computer execute:
receiving hardware description data of a circuit;
determining whether it is possible to compress number of paths in the hardware description data; and
optimizing the hardware description data based on determination at the determining.

13. The computer-readable recording medium according to claim 12, wherein the computer program further makes the computer execute computing total number of paths in the hardware description data optimized.

14. A computer-readable recording medium that stores a computer program for evaluating coverage, the computer product making a computer execute:
receiving hardware description data of a circuit;
determining whether it is possible to compress number of paths in the hardware description data; and
computing total number of paths in the hardware description data based on determination at the determining.
